(19) United States
(12) Patent Application Publication
(10) Pub. No.: US 2006/0210034 A1
(43) Pub. Date: Sep. 21, 2006

(54) Enabling a user to store a messaging session entry for delivery when an intended recipient is next available

(76) Inventors: Bruce A. Beadle, Round Rock, TX (US); Michael A. Paolini, Austin, TX (US); Colin James Parris, Austin, TX (US)

Correspondence Address: IBM CORP (AP);C/O AMY PATTILLO, P. O. BOX 161327, AUSTIN, TX, 78716, US

(21) Appl. No.: 11/083,211

(22) Filed: Mar. 17, 2005

(51) Int. Cl. H04M 1/64

(52) U.S. Cl. 379/88.22

(57) ABSTRACT

A method, system, and program for enabling a user to store a messaging session entry for delivery when an intended recipient is next available are provided. A messaging agent stores a message entry by a user, wherein the message entry is intended for communication in a messaging session with an intended recipient who is unavailable to receive the message entry when the message entry is entered by the user. The messaging agent then monitors the presence of the intended recipient and responsive to detecting a change in presence from “unavailable” to “available”, the messaging agent prompts the user to select whether to send the message entry to the intended recipient in a new messaging session. In addition, a user may select additional actions for the messaging agent to perform in distributing the message entry, where the additional actions are conditioned on the presence of the intended recipient and at least one non-presence based requirement.

### BACKGROUND OF THE INVENTION

1. Technical Field

The present invention relates in general to improved messaging systems and in particular to improving sender collaboration options when an intended recipient is not available to participate in a messaging session. Still more particularly, the present invention relates to enabling a user to store a messaging session entry for delivery through a messaging session when an intended recipient is next available or for delivery through an alternate collaboration system or communication system when presence-based conditions are met.

2. Description of the Related Art

The use of collaborative communications, such as instant messaging, web conferencing, text messaging, and Voice over IP (VoIP), has expanded rapidly over the last few years. A common characteristic of “collaborative communications” is that the communication is online and the communication is in real-time. Many companies are providing collaborative communication services for facilitating on-line, real-time communication between users interfacing with electronic devices or computing systems connected to a network. Further, many companies and individuals are subscribing to these collaborative communication services or building collaborative communication services into a business network.

In addition to the real-time characteristic of collaborative communications, many communication service providers also provide presence awareness as part of a collaborative communication service. “Presence” indicates the availability of a user to communicate through a particular collaboration mode based on the user's status. For example, a user's “presence” may indicate that the user is available for communication via instant messaging or that the user is available for a telephone call. In another example, a user's “presence” may indicate that the user is offline, and thus unavailable for communication via instant messaging.

By enabling “presence awareness”, a collaborative communication service provider enables each user to know the presence of other users subscribing to the collaborative communication service. In addition, in enabling “presence awareness”, the communication provider may enable other users to know the location or device through which another user is available to participate in collaborative communications.

When a user's presence indicates that the user is unavailable to communicate via instant messaging, then a collaborative communication service may block other users from composing messages for the unavailable user. Blocking a user from composing a message for an unavailable user is not advantageous because, for example, the user may not remember what message needed to be sent by the time the unavailable user is next available.

In another example, when a user's presence indicates that the user is unavailable to communicate via instant messaging, a collaborative communication service may enable other users to compose and send messages that are stored by the collaborative communication service and automatically delivered to the user when the user is next available. Storing a message for automatic delivery is also not advantageous, however, because the message may no longer be necessary or timely by the time intended recipient is next available.

Therefore, in view of the foregoing, it would be advantageous to provide a method, system, and program for enabling a user to compose and store a message entry intended for a particular recipient during a time when that particular recipient is not available, monitoring a presence of the particular recipient, and prompting the recipient to decide whether to send the stored message entry when the particular recipient is next available to receive messages. In addition, it would be advantageous to provide a method, system, and program for enabling the user to assign presence and non-presence based conditions to the message entry that would trigger distribution of the message entry through other forms of collaborative communication if a presence or non-presence condition is met.

### SUMMARY OF THE INVENTION

Therefore, the present invention provides an improved messaging systems and in particular provides an improved method, system, and program for improving sender messaging options when an intended recipient is not available. Still more particularly, the present invention provides a method, system, and program for enabling a user to store a messaging session entry for delivery through a messaging session when an intended recipient is next available.

According to one embodiment, an action controller in a messaging system stores a message entry by a user, wherein the message entry is intended for communication in a messaging session with an intended recipient who is unavailable to receive the message entry when the message entry is entered by the user. The action controller then monitors the presence of the intended recipient and responsive to detecting a change in presence from “unavailable” to “available”, the action controller prompts the user to select whether to send the message entry to the intended recipient in a new messaging session.

In one example, the action controller detects the message entry when the user enters the message entry as part of an ongoing messaging session, but the message entry is undeliverable because of a change in the presence of the intended recipient. In another example, the action controller detects the message entry when the user enters the message entry independent of a messaging session.

When prompting the user to select whether to send the message entry to the intended recipient, the action controller enables display of a messaging window with the message entry and a selectable interface, wherein upon selection of the selectable interface, the action controller triggers the new messaging session with the intended recipient, starting the messaging session log with the previously stored message entry.

According to another embodiment, presence conditioned actions are set in association with the message entry, where a presence conditioned action designates a condition for an action for the action controller to take in distributing the message entry. In particular, the condition is based on the presence of the intended recipient and at least one non-presence based requirement. The action controller monitors whether the condition is satisfied and responsive to detecting that the condition is satisfied, the action controller performs the specified action for distributing the message entry. In one example, the action requires automatic initiation of a messaging session with the message entry. In another example, the action requires automatic initiation of an electronic mail message with the message entry. In yet another example, the action requires the automatic distribution of the message to an alternate message device or an alternate user.

A user may set presence conditioned actions that apply to the particular message entry or to selections of message entries. In addition, a third party may set presence conditioned actions that apply to specific message entries or all message entries by a group of users.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram depicting a computer in which the present method, system, and program may be implemented;

FIG. 2 is a block diagram depicting a distributed network system for facilitating distribution of electronic messages between a requester and a recipient for facilitating one embodiment of the present invention;

FIG. 3 is a block diagram depicting a network environment in which a private collaboration controller controls the flow of communications between collaboration service providers and client systems;

FIG. 4 is a block diagram depicting the components of a messaging agent;

FIG. 5 is a block diagram depicting the components of a collaboration communication server;

FIG. 6 is a block diagram depicting an illustrative example of entries in a dynamic buddy list window;

FIG. 7 is a an illustrative example depicting a presence conditioned actions selection window;

FIG. 8 is an illustrative example depicting a buddy available alert window prompting a user that an intended recipient is now available;

FIG. 9 is an illustrative example depicting a messaging session window indicating a message entry automatically included in a messaging session initiated with an intended recipient;

FIG. 10 is an illustrative example depicting a buddy availability alert window prompting a user to initiate a messaging session with a previously entered message;

FIG. 11 is a block diagram depicting business workflow rules that include presence conditioned actions for controlling the flow of collaborative communications to and from multiple collaboration-enabled systems;

FIG. 12 is a high level logic flowchart depicting a process and program performed by a collaboration communication server for monitoring changes in buddy presence, detecting presence conditioned actions triggered by changes in buddy presence, and controlling performance of triggered presence conditioned actions;

FIG. 13 is a high level logic flowchart depicting a process and program performed by a messaging agent for responding to requests from a collaboration communication server to perform an action triggered by a change in presence of a buddy;

FIG. 14 is a high level logic flowchart depicting a process and program performed by a messaging agent for monitoring changes in buddy presence, detecting presence conditioned actions triggered by the changes in buddy presence, and directing performance of the presence conditioned actions;

FIG. 15 is a high level logic flowchart of a process and program performed by a messaging agent in facilitating a user selection of presence conditioned actions;

FIG. 16 is a high level logic flowchart of a process and program performed by a messaging agent in facilitating a user selection of conditions for a message entry intended for a recipient who is currently unavailable; and

FIG. 17 is an illustrative example depicting a presence conditioned action selection window when there are multiple intended recipients of a message entry.

### DETAILED DESCRIPTION OF THE PREFERRED EMBODIMENT

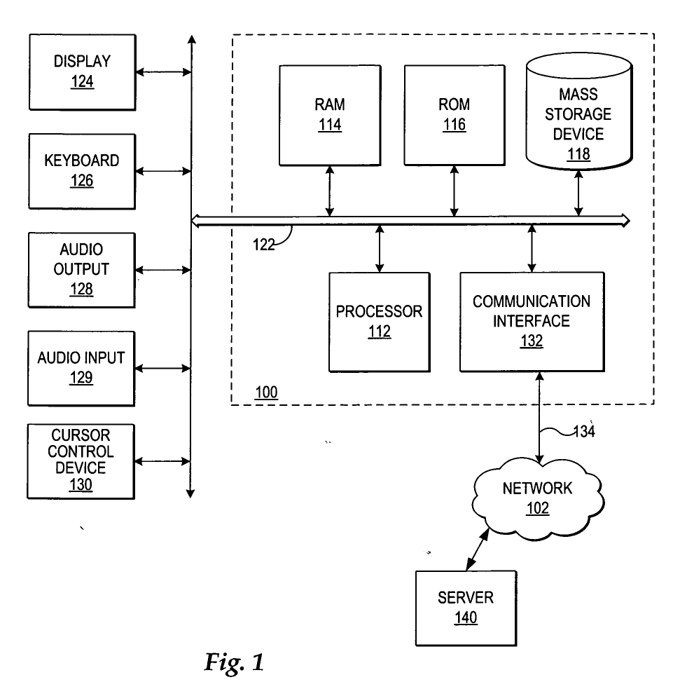

Referring now to the drawings and in particular to FIG. 1, a block diagram depicts one embodiment of a computer which may implement the present invention. In particular, a computer may include multiple types of systems, including, but not limited to, a computer system 100 and including multiple combinations of computer systems and electronic devices.

Computer system 100 includes a bus 122 or other communication device for communicating information within computer system 100, and at least one processing device such as processor 112, coupled to bus 122 for processing information. Bus 122 includes low-latency and higher latency paths connected by bridges and adapters and controlled within computer system 100 by multiple bus controllers. When implemented as a server system, computer system 100 typically includes multiple processors designed to improve network servicing power.

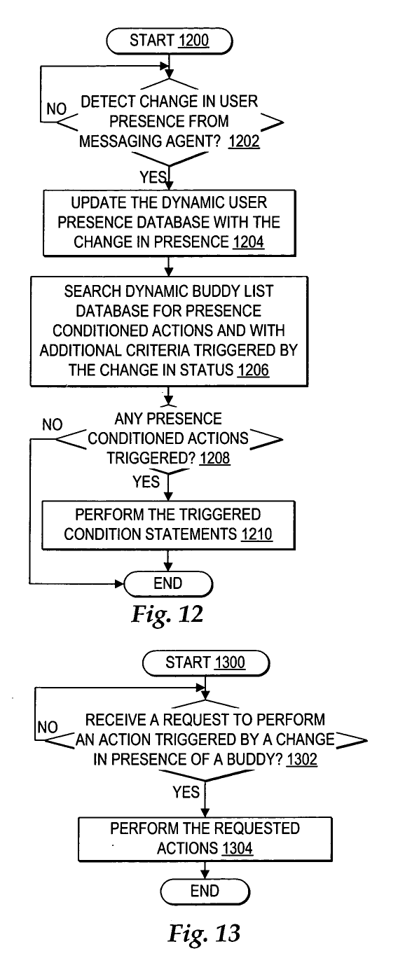

Processor 112 may include a general-purpose processor such as IBM's PowerPCTM processor that, during normal operation, processes data under the control of operating system and application software accessible from a dynamic storage device, such as random access memory (RAM) 114, and a static storage device, such as Read Only Memory (ROM) 116. The operating system may provide a graphical user interface (GUI) to the user. In a preferred embodiment, application software contains machine executable instructions that when executed on processor 112 carry out the operations depicted in the flowcharts of FIGS. 12-16, and other operations described herein. Alternatively, the steps of the present invention might be performed by specific hardware components that contain hardwired logic for performing the steps, or by any combination of programmed computer components and custom hardware components.

A computer program product may incorporate the present invention, where the computer program product is implemented through a machine-readable medium having stored thereon the machine executable instructions used to program computer system 100 to perform a process according to the present invention. The term “machine-readable medium” as used herein includes any medium that participates in providing instructions to processor 112 or other components of computer system 100 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 100 can read and which is suitable for storing instructions. In the present embodiment, an example of a non-volatile medium is mass storage device 118 which as depicted is an internal component of computer system 100, but may also be implemented as an external component. Volatile media include dynamic memory such as RAM 114. Transmission media include coaxial cables, copper wire or fiber optics, including the wires that comprise bus 122. Transmission media can also take the form of acoustic or light waves, such as those generated during radio frequency or infrared data communications.

Moreover, computer system 100 may download the present invention as a computer program product, receiving the program instructions from a remote computer such as a server 140 by way of data signals embodied in a carrier wave or other propagation medium via a network link 134 (e.g. a modem or network connection) to a communications interface 132 coupled to bus 122. Communications interface 132 provides a two-way data communications coupling to network link 134 that may be connected, for example, to a local area network (LAN), wide area network (WAN), or directly to an Internet Service Provider (ISP). In particular, network link 134 may provide wired and/or wireless network communications to one or more networks.

Network link 134 in turn provides data communication services through network 102. Network 102 may refer to the worldwide collection of networks and gateways that use a particular protocol, such as Transmission Control Protocol (TCP) and Internet Protocol (IP), to communicate with one another. Network link 134 and network 102 both use electrical, electromagnetic, or optical signals that carry digital data streams. The signals through the various networks and the signals on network link 134 and through communication interface 132, which carry the digital data to and from computer system 100, are exemplary forms of carrier waves transporting the information.

When implemented as a server system, computer system 100 typically includes multiple communication interfaces (not depicted) accessible via multiple peripheral component interconnect (PCI) bus bridges (not depicted) connected to an input/output controller (not depicted). In this manner, computer system 100 allows connections to multiple systems via network 102.

In addition, computer system 100 typically includes multiple peripheral components that facilitate communication. These peripheral components are connected to multiple controllers, adapters, and expansion slots coupled to one of the multiple levels of bus 122. For example, an audio output device 128 and audio input device 129 are connectively enabled on bus 122 for controlling audio outputs and inputs. A display device 124 is also connectively enabled on bus 122 for providing visual, tactile or other graphical representation formats and a cursor control device 130 is connectively enabled on bus 122 for controlling the location of a pointer within display device 124. A keyboard 126 is connectively enabled on bus 122 as an interface for user inputs to computer system 100. In alternate embodiments of the present invention, additional input and output peripheral components may be added.

Those of ordinary skill in the art will appreciate that the hardware depicted in FIG. 1 may vary. Furthermore, those of ordinary skill in the art will appreciate that the depicted example is not meant to imply architectural limitations with respect to the present invention.

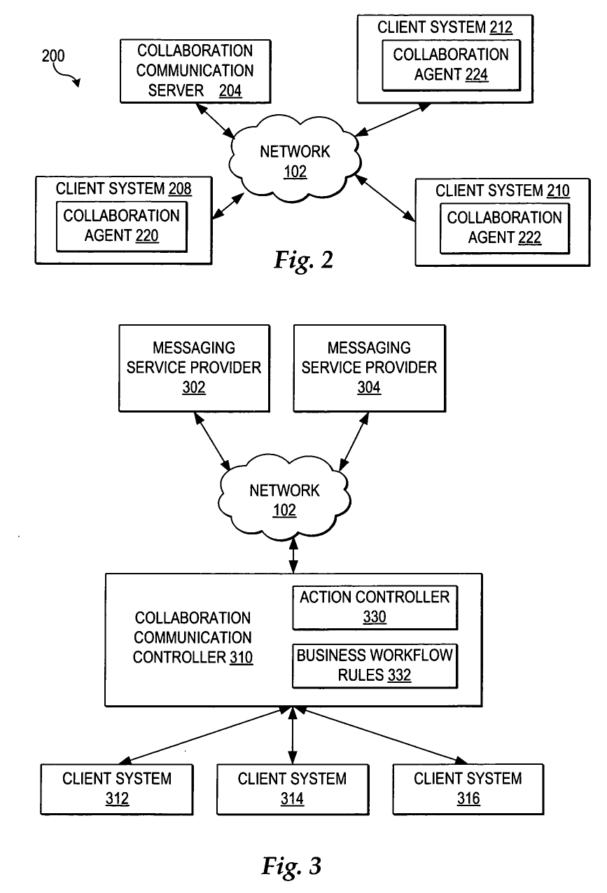

With reference now to FIG. 2, a block diagram depicts a distributed network system for facilitating collaborative communications between a sender and an intended recipient for facilitating one embodiment of the present invention. Distributed network 200 is a network of computers in which one embodiment of the invention may be implemented. It will be understood that other embodiments of systems enabled to communicate via a connection may implement the present invention.

In the embodiment, distributed network 200 includes network 102, which is the medium used to provide communications links between various devices and computers connected together within distributed network 200. Network 102 may include permanent connections, such as wire or fiber optics cables, and temporary connections made through telephone connections and wireless transmission connections, for example.

In the depicted example, network 102 enables communicative connection between a collaboration communication server 240 and client systems 208, 210, and 212. It will be understood that each of collaboration communication server 204 and client systems 208, 210, and 212 may be distributed in geographically disparate locations throughout heterogeneous types of computing systems operating within disparate local networks. In addition, it will be understood that distributed network 200 may include additional services, clients, networks, and other devices that are not shown.

In one embodiment, distributed network 200 includes a client/server environment where collaboration communication server 204 performs as a server for responding to requests and client systems 208, 210, and 212 perform as clients requesting communication services from collaboration communication server 204. Many different network architectures may implement the client/server environment of distributed network 200. In one example, distributed network 100 is the Internet with network 102 representing a worldwide collection of networks and gateways that use the TCP/IP suite of protocols to communicate with one another. Millions of high-speed data communication lines between major nodes or host computers enable the Internet. In another example, distributed network 200 includes an intranet, a local area network (LAN), or a wide area network (WAN). Moreover, distributed network 200 may include networks employing alternatives to a traditional client/server environment, such as a grid computing environment.

Within distributed network 200, each of client systems 208, 210, and 212 and collaboration communication server 204 may function as both a “client” and a “server” and may be implemented as computer through a single or multiple computer systems, such as computer system 100 of FIG. 1. Further, while the present invention is described with emphasis upon collaboration communication server 204 facilitating the transfer of electronic messages and communications, clients 208, 210, and 212 may also perform collaborative communications by engaging in peer-to-peer network communications via network 102.

In particular, collaborative communication server 204 may provide communication services for facilitating multiple types of collaborative communications including, but not limited to, instant messaging communications, chat room communications, text messaging, short message service (SMS) messaging, VoIP, and other forms of electronic communications that occur in “real-time” and are supported within distributed network 200. A “messaging session” describes a communication where collaborative communication server 204 opens a channel for real-time communication via network 102 between at least two users. Each user participating in a messaging session communicates through message entries which may include text, voice, video, graphics, robotic touch, motion entry, and tactile entry. An additional user may enter an already ongoing messaging session, but like a telephone conversation which occurs in real-time, the additional user only receives those message entries entered by users after the additional user joins.

In addition, it is important to note that for collaborative communications, a user may be identified by a user identifier (user ID) in multiple forms including, but not limited to, an e-mail address, an IM name, a chat name, a telephone number, and other electronic communication identifiers. In addition, a single user may be associated with multiple user ID's. For example, a user may have a work user ID and a personal user ID. In addition, a user's ID may vary based on the device at which the user participates in a messaging session.

In particular, each of client systems 208, 210, and 212 may include collaborative agents, such as collaborative agents 220, 222, and 224 that enable a user at each of client systems 208, 210, and 212, through a supported user interface, to initiate a collaborative communication through communication server 204 to another one of the client systems 208, 210, and 212 and enable a user at each of client systems 208, 210, and 212 to receive collaborative communication requests and respond to collaborative communication requests. In one example, a user may “log on” at a client system through a collaborative agent that supports instant messaging, such as logging on at client system 208 through agent 220, wherein agent 220 requests a communication channel for a messaging session between client system 208 and communication server 204.

Each of client systems 208, 210, and 212 and communication server 204 detects a user's “presence” and may distribute the user's “presence” to the others of client systems 208, 210, and 212 and communication server 204 in the form of a presence indicator, for example. A user's “presence” generally indicates a user's availability to participate in each type of collaborative communication available to the user. For example, a user's presence indicator may specify that the user is available to participate in a messaging session and to receive VoIP communications, thus indicating the user's availability to participate in two types of collaborative communications. In addition, a presence indicator may provide information in addition to “available” or “unavailable”, such as “on the phone”, “out to lunch”, “only business related communications”, and other specific indicators of presence selected by the user or determined by the system detecting a user's presence.

In one embodiment, agent 220 offers a user a selectable interface for the user to designate a presence indicator by selecting an availability to participate in different types of communications. In another embodiment, agent 220 may detect user activity at client system 208 and automatically designate the user's presence based on activity. For example, if agent 220 detects client system 208 sitting idle for more than thirty minutes, then agent 220 may automatically designate a user's presence indicator as “unavailable”. In another example, if agent 220 detects that a user has not responded to communication requests for more than ten minutes, then agent 220 may automatically designate a user's presence indicator as “away”. In yet another embodiment, agent 220 may infer and select a user's presence by detecting whether the user is currently using a telephone or other electronic device to communicate. In a further embodiment, agent 220 may search for a user's electronic calendar and to-do lists and infer the user's actual availability and may adjust the “presence” to reflect actual availability. For example, through a selectable interface, a user may select “available to participate in messaging sessions” to indicate availability, however agent 220 may detect that the user's calendar indicates a conference call and automatically update the user's presence to indicate “in a conference call”.

In particular, when a user specifies “presence” for a particular user ID or at a particular device, the user may categorize the types of communications that the user is available to receive. For example, a user may select, for a particular IM user ID, that the user is only available for personal communications. Thus, a user may have a single IM user ID, but select which categories of communications are available through that user ID.

According to an advantage, client systems 208, 210, and 212 and communication server 204 respond to changes in the presence of users within distributed network 200. In particular, as will be further described, client systems 208, 210, and 212 and collaboration communication server 204 may respond to changes in the presence of users when presence conditioned actions are triggered by the change in presence of a particular user or group of users. Presence conditioned actions may include a single or multiple rules that must be met by a particular presence indicator of a user or groups of users to trigger an action. In addition, presence conditioned actions may include a non-presence condition that must be met to trigger the action. Further, presence conditioned actions may include rules selected by an individual user, rules selected by a third party, rules selected by a collaborative communication provider, rules selected by a business, and other entities.

With reference now to FIG. 3, a block diagram depicts a network environment in which a private collaboration controller controls the flow of communications between collaboration service providers and client systems in accordance with the method, system, and program of the present invention. In the embodiment, multiple messaging service providers 302 and 304 facilitate collaboration messaging services for multiple client systems 312, 314, and 316. In one example, messaging service providers 302 and 304 include public messaging service providers, such as America Online Inc. and Yahoo! Inc., that provide instant messaging services, such as AIM (AIM is a registered trademark of America Online, Inc.) and Yahoo! Messenger (Yahoo! is a registered trademark of Yahoo! Inc.). In another example, either of messaging service providers 312 and 314 may include private messaging service providers that provide messaging services for a particular business network or enterprise. In addition, in one example, each of client systems 312, 314, and 316 may include a single messaging agent or multiple messaging agents, where each messaging agent facilitates communication with one of messaging service providers 302 and 304.

In the example depicted, a private collaboration communication controller 310 controls the flow of communications sent to and from client systems 312, 314, and 316. As will be further described, an action controller 330 within private collaboration messaging controller 310 filters messaging communications through business workflow rules 332 and triggers additional actions designated by relevant business rules within business workflow rules 332. In particular, business workflow rules 332 may designate policies for controlling the content and flow of collaboration communications to and from client systems 312, 314, and 316. In one example, a corporation or other third party may impose business workflow rules that control the content and flow of collaboration communications to and from client systems. In another example, a parent may set business workflow rules that a third party collaboration communication controller 310 imposes on communications by children.

As will be further discussed, private collaboration communication controller 310 may also detect or set the presence of users with access to client systems 312, 314, and 316 and filter how other systems receive the user “presence”. In particular, business workflow rules 332 may designate the type of presence about a user that can be distributed according to the user and according to the recipient of the presence.

In addition, the business workflow rules 332 imposed on messaging workflows to and from client systems 312, 314, and 316 may include presence conditioned actions. In particular, action controller 330 may trigger client systems 312, 314, and 316 to perform presence conditioned actions or action controller 330 may perform the presence conditioned actions.

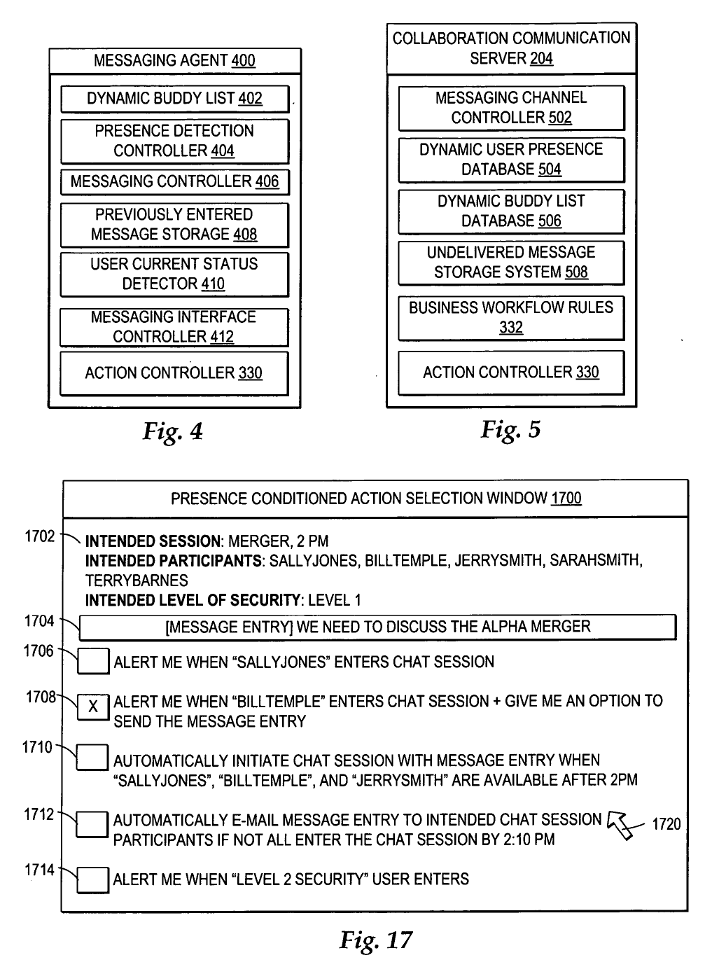

With reference now to FIG. 4, a block diagram depicts the components of a messaging agent in accordance with the method, system, and program of the present invention. As illustrated, a messaging agent 400, executing on a client system, performs the functions described for the messaging agents described with reference to FIG. 2. For purposes of illustration, messaging agent 400 enables communication with a collaboration communication controller that facilitates messaging session. It will be understood that other types of agents may facilitate other types of collaboration communications.

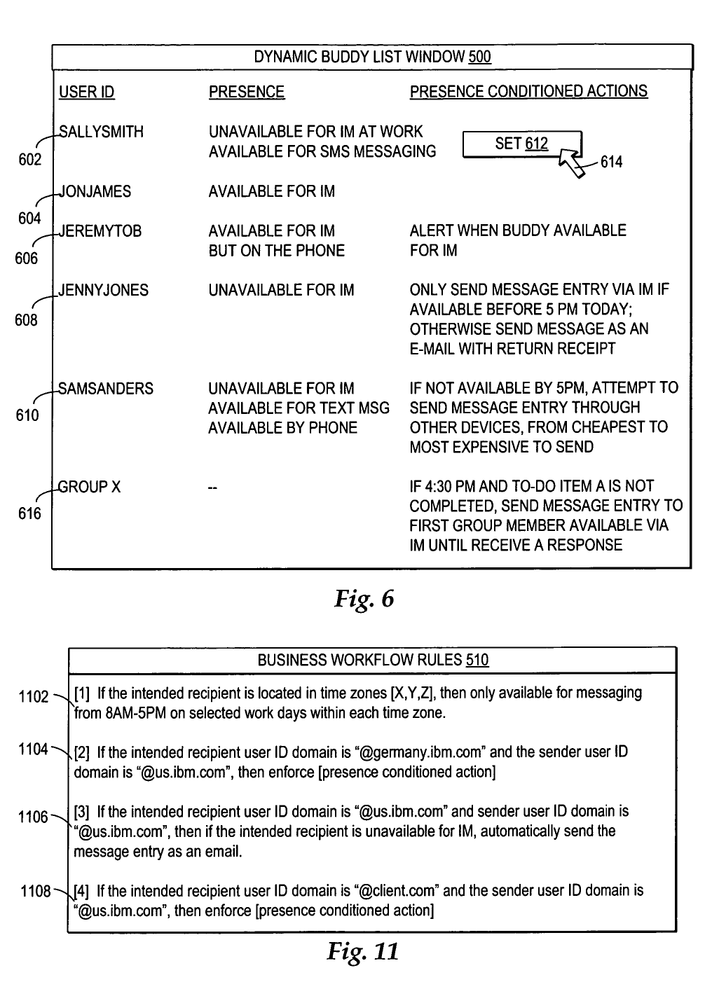

In the example, messaging agent 400 includes a dynamic buddy list 402, which will be further described with reference to FIG. 6. In general, dynamic buddy list 402 includes the user IDs for multiple users that a particular user designates as “buddies” and the dynamically updated presence indicators of each buddy to participate in collaboration communications, and in particular to participate in messaging sessions. In one example, a presence detection controller 404 periodically queries collaboration communication sever 204 to access a current presence indicator for each user included in dynamic buddy list 402.

In addition, according to an advantage, dynamic buddy list 402 includes selections of presence conditioned actions to be triggered when a buddy's presence changes and other non-presence based conditions are met. It is important to note that presence conditioned actions include at least one presence based condition, but may also include non-presence based conditions. Non-presence based conditions may include, but are not limited to, time based conditions, activity based conditions, and conditions based on whether another presence conditioned action is triggered.

In particular, activity based conditions included in a presence conditioned action in dynamic buddy list 402 may include schedule based activities, user activity at a computing system, and other activity detected by user current status detector 410 and other activity detectors. In one example, user current status detector 410 may monitor an electronic calendar and to-do lists for a user for current status indicators, where the electronic calendar and to-do lists are available via a network or at the same system running messaging agent 400. In another example, current status detector 410 may detect that a mode that the user's computer system is operating under, such as a presentation mode when the user is running presentation software, a programming mode when the user is interacting with a programming software interface, or a communication mode when the user is interacting with a messaging software interface. In one example of “other activity detected by user current status detector 410”, a user may select for user current status detector 410 to monitor activity and data at other systems accessible via a network. For example, a user may select for current status detector 410 to monitor whether a particular show has sold out by monitoring the number of tickets designated on a particular web page.

It is important to note that conditioned actions within dynamic buddy list 402 generally include alerting actions and sending actions. In one example, an alerting action may include opening an alert window to alert a user that a buddy's presence has changed and to request that the user select whether to send a previously entered message. In another example, a sending action may include detecting another device at which a buddy is present and forwarding a communication entry to that device.

According to an advantage of the invention, conditioned actions may designate the flow of previously entered message entries that are entered when a buddy is not available to receive messaging communication requests and stored in previously entered message storage 408 or at collaboration communication server 204. For example, a conditioned action may include prompting the user to send a previously entered message from previously entered message storage 408 when a buddy's presence indicates availability, sending the previously entered message to another device accessible to the buddy, and sending the previously entered message to another buddy.

A conditioned action may designate the flow of a specific previously entered message or may control previously entered messages in general. For example, a conditioned action may require messaging agent 400 to always prompt the user with an option to send a previously entered message when the buddy is next available to receive the previously entered message. In another example, a conditioned action may require messaging agent 400 to always send previously entered messages intended for a particular buddy as an email if the buddy is not available before the end of the business day.

A user may enter a “previously entered message” through multiple interfaces. For example, a user may enter a “previously entered message” through a specified user interface as controlled by a messaging interface controller 412 when a user selects the conditioned actions that control the flow of the “previously entered message”. In another example, a user may enter a “previously entered message” when messaging agent 400 detects a message entered by a user that is not deliverable or not received by a buddy. Further, in another example, a user may enter a “previously entered message” in an email that is designated to be forwarded into an instant messaging session.

It is important to note that for purposes of description, the term “buddy” is used to describe any intended recipient, whether included on dynamic buddy list 402 or included in a particular messaging session. In particular, once a presence conditioned action is associated with an intended recipient, messaging agent 400 may temporarily add the intended recipient to dynamic buddy list 402 until the intended recipient is next available. Further, a user may assign a presence conditioned action in association with a group of buddies or with a general buddy ID, where the general buddy ID is similar to a number that dials into a call center, where the first available user in a list of users associated with the general buddy ID is accessed.

A messaging controller 406 controls the flow of message entries between a client system and collaboration communication server 204 or a messaging communication controller. In particular, messaging interface controller 412 interacts with an operating system to display message entries or play message entries through interfaces accessible to a user.

According to one embodiment, action controller 330 monitors the presence conditioned actions in dynamic buddy list 402 and monitors changes in presence indicators for buddies listed in dynamic buddy list 402. Further, action controller 330 detects when conditions of presence conditioned actions are met and triggers the conditioned actions. In one example, when a buddy's presence changes to “available” then action controller 330 detects whether there are any presence conditioned actions triggered for that buddy in the dynamic buddy list 402 and performs any triggered presence conditioned actions. In another example, when a buddy's presence changes to “unavailable” then action controller 330 prompts the user to select presence conditioned actions to be performed when the buddy is next available.

According to another embodiment, when a buddy's presence changes to “unavailable” during a messaging session, action controller 330 may detect whether any message entries remain undelivered, automatically store undelivered message entries in previously entered message storage 408, monitor when that buddy availability presence changes to “available”, and prompt the user to decide whether to send the undelivered message entries in a new messaging session. In addition, when a user selects presence conditioned actions in association with a buddy, the user may enter messages which action controller 330 stores in previously entered message storage 408 and later prompts the user to decide whether to send the undelivered message entries in a new messaging session.

According to yet another embodiment, collaboration communication server 204 may detect when the presence of a buddy changes and direct action controller 330 to take selected actions in response to the change of presence. It will be understood that collaboration communication server 204 may perform other functions described as functions performed by a messaging agent at a client system.

As previously described, messaging agent 400 includes a user current status detector 410. User current status detector 410 selects a user's current presence, through analyzing a presence indicator selected by the user and by detecting the user's actual activity. As previously described, current status detector 410 may detect schedule based activity, user activity at a computing system, and other activity detectable via a network. Based on status rules set by the user (not depicted) user current status detector 410 analyzes the status indicator selected by the user and the user's actual activity to select a presence indicator for the user. In one example, if a user's status indicator selection is “available”, but the user's activity indicates that the user's computer system is operating in presentation mode, then the status rule may designate specifying the user's presence indicator as “unavailable” and further specifying the presence indicator as “in a presentation”. A user may designate a status rules set, status rules may be inferred from user activity, or a business may set status rules for employees.

Referring now to FIG. 5, a block diagram depicts the components of a collaboration communication server in accordance with the method, system, and program of the present invention. As illustrated, collaborative communication server 204 includes a messaging channel controller 502 that receives requests from multiple messaging agents, such as messaging agents 220, 222, and 224, to send message entries in messaging sessions with other users logged on at another messaging agent. In particular, messaging channel controller 502 may support a single type or multiple types of collaborative communications.

Messaging channel controller 502 checks a dynamic user presence database 504 to determine whether the intended recipient is available and detect the location of the messaging agent through which the intended recipient is logged on. If an intended recipient is available, then messaging channel controller 502 may open a communication channel between the requesting messaging agent and the receiving messaging agent and enable message communications to pass between the request messaging agent and the receiving messaging agent.

In addition, messaging channel controller 502 receives updates from messaging agents when changes in user presence occur. Messaging channel controller 502 updates dynamic user presence database 504 with the changes in user presence.

In one embodiment, collaboration communication server 204 may include a dynamic buddy list database 506 that includes the dynamic buddy lists, as described with reference to FIG. 4, for multiple users. Action controller 330 may detect when changes in presence occur and search dynamic buddy list database 506 for presence conditioned actions triggered by the changes in user presence. In another embodiment, as described with reference to FIG. 4, each messaging agent manages and monitors a dynamic buddy list based on buddy presence updates received from communication server 204.

In addition, action controller 330 may detect and store undelivered messages in an undelivered message storage system 508. In particular, action controller 330 may detect messages undelivered during a messaging session or messages entered while a buddy is not available and therefore undeliverable until the buddy is next available.

Further, according to an advantage of the invention, collaboration communication server 204 may include business workflow rules 322. Business workflow rules 322 define third party presence conditioned actions, which action controller 330 monitors and controls actions which are triggered when conditions are met. In particular, although not depicted, collaboration communication controller 310, as described with reference to FIG. 3 may also apply business workflow rules 322 to the message workflow restrictions applied to a selection of client systems.

With reference now to FIG. 6, an illustrative example depicts entries in a dynamic buddy list window in accordance with the method, system, and program of the present invention. As illustrated a dynamic buddy list window 600 includes multiple entries 602, 604, 606, and 608. Each entry includes a user identifier (ID) for a buddy, a presence, and presence conditioned actions. For purposes of illustration, when a “message entry” is referred to throughout the examples depicted in FIG. 6, the “message entry” refers to a previously entered message that is not yet delivered to the intended recipient.

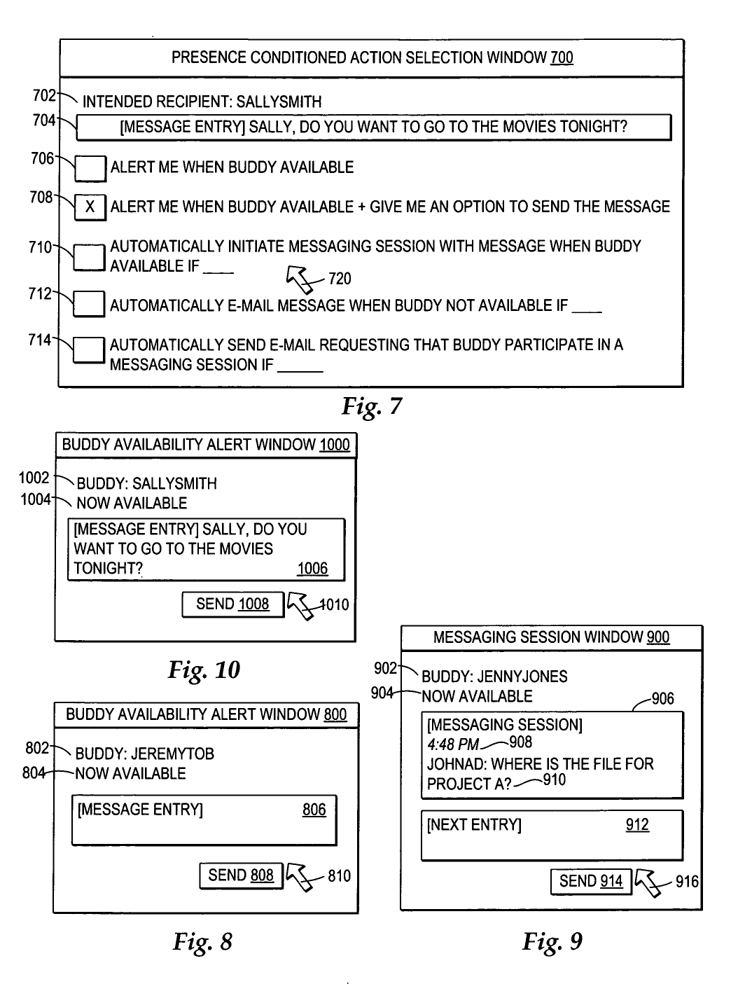

In a first example, entry 602 includes a user ID “SALLYSMITH” whose presence indicators are “unavailable for IM at work” and “available for SMS messaging”. In the first example, a user has not yet selected presence conditioned actions in association with this buddy, so message interface controller 412 prompts user with an option to set presence conditioned actions. In particular, a selectable set button 612 is displayed under the “presence conditioned actions” column, wherein upon selection of selectable set button 612, messaging interface controller 412 prompts the user to select presence conditioned actions in association with the buddy. In one example, the user may select selectable set button 612 by positioning cursor 614 over selectable set button 612 and entering a selection input or through other selection commands. Once a user selects selectable set button 612 or enters another command, messaging interface controller 412 triggers a presence conditioned action selection window, such as presence conditioned action selection window 700 of FIG. 7, to provide the user with an interface to select presence conditioned actions to be taken when the buddy's presence changes.

In a second example, entry 604 includes a user ID “JONJAMES” whose presence indicator is “available for IM”. When a user's presence indicator is “available for IM”, action controller 330 may reset the presence conditioned actions for the buddy. In another embodiment, action controller 330 may enable a user to select conditioned actions for any type of change in buddy presence, such as a buddy presence changing from “available to IM” to “unavailable to IM”. For example, a user may select a presence conditioned action to automatically store a message log of all open messaging sessions with a buddy when the buddy's presence changes from “available to IM” to “unavailable to IM”.

In a third example, entry 606 includes a user ID “JEREMYTOB” whose presence indicator is “available for IM, but on the phone”, to indicate both the user presence selection and the actual user activity detected. In this example, entry 606 indicates that the user already selected presence conditioned actions in association with this buddy. In particular, entry 606 indicates the user selection to receive an “alert when buddy is available for IM”. In this example, when the buddy presence changes to indicate the buddy is “available for IM” and no longer indicates the that buddy is “on the phone”, then action controller 330 triggers the action of alerting the user that the buddy is available for IM. In this example, action controller 330 infers that the presence indicator of “available for IM but on the phone” does not indicate an availability for IM.

In particular, FIG. 8 depicts an illustrative example of a buddy availability alert window 800 triggered responsive to a change of presence of “JEREMYTOB” according to the presence conditioned action of “alert when buddy is available for IM”. In particular, buddy availability alert window 800 depicts the buddy ID of “JEREMYTOB” at reference numeral 802 and the updated presence of “available” at reference numeral 804. Buddy availability alert window 800 also includes a message entry area 806 in which a user may enter a message and request to initiate a messaging session with “JEREMYTOB” with the message by selecting send button 808 through the positioning of cursor 810.

Returning to FIG. 6, in a fourth example, entry 608 includes a user ID “JENNYJONES” whose presence indicator is “unavailable for IM”. In this example, entry 608 indicates that the user already selected presence conditioned actions in association with this buddy. In particular, entry 608 indicates the user selection to “only send a message entry via IM if available before 5 PM today, and otherwise send the message as an e-mail with return receipt.” In this example, action controller 330 monitors whether the buddy presence changes to indicate the buddy is “available for IM” before 5 PM. If the buddy presence changes and the non-presence time condition of “5 PM” is not yet reached, then action controller 330 triggers sending the previously entered message entry through IM. However, once the time based condition of 5 PM is reached, if the buddy presence has not changed to indicate the buddy is “available for IM”, then action controller 330 triggers the action of sending the message entry as an e-mail with a return receipt.

In a fifth example, entry 610 includes a user ID “SAMSANDERS” whose presence indicator is “unavailable for IM”, “available for text messaging”, and “available by phone”. In this example, entry 610 indicates that the user already selected presence conditioned actions in association with this buddy. In particular entry 610 indicates the user selection of “if not available by 5 PM, attempt to send message entry through other devices, from cheapest to send to most expensive to send.” In this example, the when action controller 330 monitors for a presence of the buddy change prior to 5 PM and triggers the actions of sending the message entry through other devices if the presence does not change prior to 5 PM. As previously described, a user may have a different user ID at each collaboration communication device or a single consolidated user ID. While sending an instant message entry is typically low in cost, sending a collaboration communication to a telephony device may include a text messaging cost. Thus, action controller 330 orders attempts to contact the user via other collaboration communication devices according to cost. In one embodiment, collaboration communication server 204 may maintain a presence of a user at multiple devices in dynamic user presence database 504, with a cost associated with communication with the user at each of the multiple devices.

In a sixth example, entry 616 includes a user ID “GROUP X”, which represents a group of users. For purposes of illustration, “GROUP X” includes multiple employees who are part of a product team and the presence of each of the multiple employees is tracked, however not depicted. A presence conditioned action is set to apply to all users within the group. In the example, action controller 330 would monitor whether it is 4:30 PM, and when it is 4:30 PM, would detect whether a particular to-do item “A” is not marked completed. If the to-do item is not marked completed, then action controller 330 sends a message entry to each available group member available via IM, until a response is received. A second conditioned action checks whether it is after 4:45 and no response is received. If it is after 4:45 PM and no response is received, then an action to send the message entry through text messaging to each member is triggered.

It will be understood that the entries depicted within dynamic buddy list window 600 are examples of the types of user IDs, presence indicators, and presence conditioned actions that dynamic buddy list 402 may include. In particular, dynamic buddy list window may include additional types of presence indicators and presence conditioned actions. In addition, it will be understood that while in the example, dynamic buddy list window 600 implements textual indicators of current presence and selected presence conditioned actions, in alternate embodiments, textual indicators may be represented by graphics, sounds, tactile prompts, and other interface available output types.

Further, although not depicted, it is important to note that each presence conditioned action and previously entered message may include an automatic expiration date. For example, a user may select for all previously entered messages to automatically expire after ten hours, where action controller 330 monitors the expiration of each previously entered message and deletes expired messages from previously entered message storage 408.

Referring now to FIG. 7, there is depicted an illustrative example of a buddy presence conditioned actions selection window in accordance with the method, system, and program of the present invention. As depicted, a presence conditioned action selection window 700, displayed within a user interface, facilitates user selection of presence and non-presence conditioned actions in association with one or more intended recipients and in association with a message entry that is not yet delivered. In one example, messaging interface controller 412 may invoke presence conditioned action selection window 700 in response to a user selection of selectable set button 612 in FIG. 6. In another example, messaging interface controller 412 or action controller 330 may invoke presence conditioned action selection window 700 responsive to other user input or responsive to any change in the presence of a buddy or other intended recipient.

Presence conditioned action selection window 700 includes an identifier for an intended recipient associated with the presence conditioned actions. In the example, as illustrated at reference numeral 702, user ID “SALLYSMITH” is designated as the intended recipient. In alternate embodiments, a user may select a group of intended recipients, a list of multiple individual intended recipients, or other designations of intended recipients.

Next, presence conditioned action selection window 700 includes a message entry area, as illustrated at reference numeral 704, into which a user may add a textual, voice, or other type of message entry that will be stored as a “previously entered message”. In particular, a user may enter a message, such as the example message of “sally, do you want to go to the movies tonight?” that is received and stored in previously entered message storage 408 while the intended recipient is not available to receive instant messages.

In addition, presence conditioned action selection window 700 includes multiple selectable presence conditioned actions with an ability to add non-presence conditions for triggering the conditioned actions. It will be understood that presence conditioned action selection window 700 may include selectable presence conditioned actions in addition to those displayed or may enable a user to piece together a presence conditioned action. In addition, collaboration communication server 204 may monitor presence conditioned actions created by other users or designated by a third party and update action controller 330 with new presence conditioned actions to add to presence conditioned action selection window 700. Further, in one example, a user may select from selectable presence conditioned actions by positioning cursor 720 over an action and entering a command or other input.

In particular, a selectable presence conditioned action depicted at reference numeral 706 allows a user to select to receive an alert when the intended recipient logs on. Although not depicted, a user may also select the type of alert to receive or may designate a default alert type, such as a pop-up window with an alert message. Additionally, in association with any alert, a user may select an exception if current activity indicates the user should not receive alerts. For example, user current status detector 410 may detect that a user's computer system is in “presentation mode” and determine that the user's presence is “unavailable to receive alerts” based on the user's computer system activity.

Next, a selectable presence conditioned action depicted at reference numeral 708 allows a user to select to receive an alert when the buddy logs on with an option to send the entered message depicted at reference numeral 704. As depicted, the user chooses selectable presence conditioned action depicted at reference numeral 708 in association with an intended recipient “SALLYSMITH”. Responsive to action controller 330 detecting that “SALLYSMITH” is available, action controller 330 triggers the presence conditioned action associated with “SALLYSMITH” by opening an alert window with an option to send the previously entered message, such as a buddy availability alert window 1000 depicted in FIG. 10. In particular, buddy availability alert window 1000 depicts the user ID of “SALLYSMITH” at reference numeral 1002 and the updated presence indicator of “available” at reference numeral 1004. Buddy availability alert window 1000 also includes a message entry area 1006 with the previously entered message, wherein the message was previously entered as illustrated at reference numeral 704 of FIG. 7. The user may select to send the previously entered message in message entry area 1006 to initiate a messaging session by selecting send button 1008 through the position of cursor 1010, for example.

Returning to FIG. 7, a selectable presence conditioned action depicted at reference numeral 710 allows a user to select to automatically start a messaging session with a previously entered message when the intended recipient is next available if another non-presence condition is met. In one example, entry 608 of FIG. 6 indicates a user selection of the automatic send selectable condition in association with “JENNYJONES” with a non-presence condition that the detected availability occurs before 5 PM today. Action controller 330 monitors the presence of “JENNYJONES” and whether the time is prior to 5 PM. If action controller 330 detects the user presence change to “available for IM” and the non-presence condition of “before 5 PM today” is met, then action controller 330 automatically triggers a messaging session with the message entry indicated at reference numeral 704 and displays the messaging session interface through a messaging session window, such as messaging session window 900 depicted in FIG. 9. In particular, messaging session window 900 depicts the user ID of “JENNYJONES” at reference numeral 902 and the updated presence indicator of “available” at reference numeral 904. Messaging session window 900 also indicates, as depicted at reference numeral 906, that action controller 330 triggered a messaging session with buddy “JENNYJONES”. In particular, as depicted at reference numeral 908, action controller 330 triggered the messaging session at 4:48 PM, which is prior to the 5 PM time limit. In addition, as illustrated at reference numeral 910, action controller 330 triggered the messaging session with a message entry previously entered by the user. A message entry area 912 provides an area for the user to enter a next message entry and select to send the message entry by selecting selectable button 914 through the position of cursor 916, for example.

In addition, a selectable presence conditioned action depicted at reference numeral 712 allows a user to select to send a message as an e-mail if a presence or non-presence condition occurs or does not occur. For example, entry 608 of FIG. 6 indicates a user selection of the selectable conditioned action depicted at reference numeral 710 and the selectable conditioned action depicted at reference numeral 712. As a result of the combination, according to the presence conditioned action illustrated in entry 608, if action controller 330 detects that buddy “JENNYJONES” does not log on before 5 PM today, then action controller 330 will trigger sending the message previously entered by the user as an e-mail to “JENNYJONES.” In addition, although not depicted, the user may also select whether to automatically request a return receipt with the e-mail.

In another example, a selectable presence conditioned action depicted at reference numeral 714 allows a user to select to send an e-mail to the buddy requesting that the buddy log on and participate in a messaging session. A user may select additional conditions for sending the e-mail requesting messaging session participation. For example, a user may select to condition the sending of a “please participate” e-mail only after the buddy has not logged on during a scheduled messaging session. In another example, the user may select to condition the sending of a “please participate” e-mail to trigger every two hours until the buddy logs on and is available to participate in a messaging session.

With reference now to FIG. 11, a block diagram depicts business workflow rules that include presence conditioned actions for controlling the flow of collaborative communications to and from multiple collaboration-enabled systems. In the example, business workflow rules 332 indicate the rules for action controller 330 to apply to control collaborative communications by employees of a particular business. In another example, business workflow rules may indicate the rules for controlling collaborative communications by citizens under a particular government. In general, it will be understood that one party may establish business workflow rules 332 that are applied to collaborative communications by multiple users. Further, according to an advantage, business workflow rules 332 may include presence conditioned actions.

In a first example, a rule may designate work day regulations of a state or country. In particular, rule 1102 enforces the workday hours based on the physical presence of a user. In one example, rule 1102 designates that if an intended recipient is physically located within selected time zones, then the intended recipient is only available for instant messaging from 8 AM to 5 PM on certain days in that time zone to enforce workday limitations. In addition, 20 the rule may restrict communications on holidays and religious days, for example. In one example, a network accessed by an intended recipient may report the current time zone for a user. In another example, the collaboration-enabled devices for a user may detect the current time zone as entered by the user or from a network location. In particular, it may be advantageous for a business to limit the hours that an intended recipient can be contacted via collaborative communications to enforce the workday in each time zone.

In a second example, a rule may designate restrictions of international law, such as export restrictions or information flow restrictions, for example. In particular, rule 1104 enforces communication flow based on the country associated with a user ID domain. In particular, rule 1104 designates that if an intended recipient user ID is associated with the domain “@germany.ibm.com”, which is assigned to employees of a company working in Germany, and the sender user ID is associated with the domain “@us.ibm.com”, which is assigned to employees of a company working in the United States, then certain presence conditioned action and associated with international law are applicable.

In a third example, a rule may designate restrictions for communications by employees of a same company. For example, rule 1106 enforces presence conditioned actions when the recipient user ID domain and the sender user ID domain are the same domain. In particular, rule 1106 designates that if an intended recipient user ID is associated with the domain “@us.ibm.com” and the sender user ID is associated with the domain “@us.ibm.com”, then if the intended recipient is unavailable for IM, the message entry is automatically sent as an e-mail. In particular, according to an advantage, the user interface for entry of an instant message impliedly serves as a user interface for entry of an email message, such that the sender is not required to enter the message in two separate interfaces when the intended recipient is not available for instant messaging.

In a fourth example, a rule may designate restrictions for communications between employees of one company and employees of another company or companies. For example, rule 1108 enforces presence conditioned actions when the messaging communication is between an intended recipient with the user ID domain of “@client.com” and a sender with the user ID domain of “@us.ibm.com”. In particular, a business may want to enforce certain messaging actions between its employees and the employees of a client or a competitor.

It is important to note that in some cases, multiple rules may apply to a single message entry communication. In the case where multiple rules apply, each rule may be assigned a priority or level in a hierarchy and action controller 330 applies the rule with the highest priority. In another example, where multiple rules apply, action controller 330 may only apply the portions of each rule that overlaps one another rule.

Referring now to FIG. 12, a high level logic flowchart depicts a process and program performed by a communication server for monitoring changes in buddy presence, detecting presence conditioned actions triggered by changes in buddy presence, and controlling performance of triggered presence conditioned actions. As illustrated, the process performed by the messaging controller of a collaboration communication server starts at block 1200 and thereafter proceeds to block 1202. Block 1202 depicts a determination whether the messaging controller receives a change in presence notification from a messaging agent at a client system. If the messaging controller receives a change in presence notification from a messaging agent at a client system, then the process passes to block 1204. Block 1204 depicts the messaging controller updating the dynamic user presence database with the change in presence notification. Next, block 1206 depicts the action controller searching the dynamic buddy list database for any presence conditioned actions triggered by the change in presence and determining whether additional conditions are also met. Thereafter, block 1208 depicts a determination by the action controller whether any presence conditioned actions are triggered by the change in presence and any additional conditions are met. If the change in presence of the user does not trigger any presence conditioned actions, then the process ends. Otherwise, if the change in user presence triggers presence conditioned actions, then the process passes to block 1210. Block 1210 depicts controlling performance of the triggered presence conditioned actions, and the process ends.

With reference now to FIG. 13, a high level logic flowchart depicts a process and program performed by a messaging agent for responding to requests from a collaboration communication server to perform an action triggered by a change in presence of a buddy. As illustrated, the process performed by the messaging agent starts at block 1300 and thereafter proceeds to block 1302. Block 1302 depicts a determination whether the messaging agent receives a request from the collaboration communication server to perform an action triggered by the change in presence of a buddy of a user logged in to the messaging agent. If the messaging agent receives a request from the communication server to perform an action triggered by the change in presence of a buddy, then the process passes to block 1304. Block 1304 depicts performing the requested actions, such as opening an alert window, and the process ends.

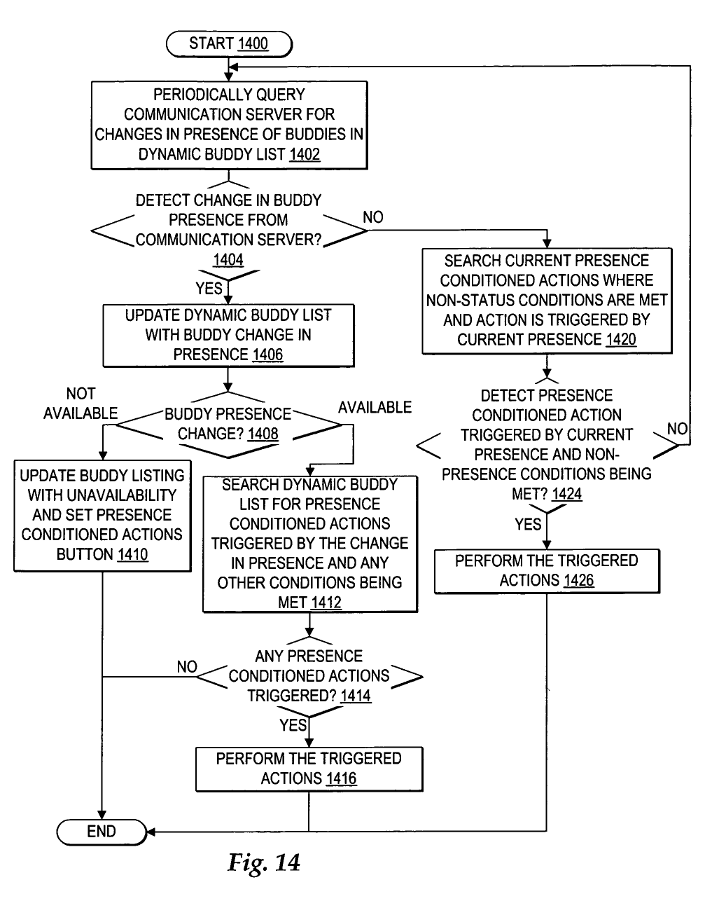

Referring now to FIG. 14, there is depicted a high level logic flowchart of a process and program performed by a messaging agent for monitoring changes in buddy presence, detecting presence conditioned actions triggered by the changes in buddy presence, and directing performance of the presence conditioned actions. As illustrated, the process performed by the messaging agent start at block 1400 and thereafter proceeds to block 1402.

Block 1402 depicts the messaging agent periodically querying the collaboration communication server for changes in presence of buddies in a dynamic buddy list. Next, block 1404 depicts a determination by the messaging agent whether there is a change in a buddy presence detected. If there is not a change in buddy presence detected, then the process passes to block 1420.

Block 1420 depicts the messaging agent searching the current presence conditioned actions for non-presence conditions that are met and actions triggered by the current presence. Next, block 1424 depicts a determination whether any presence conditioned actions are triggered by the current presence and non-presence conditioned being met. If no presence conditioned actions are triggered, then the process returns to block 1402. Otherwise, if any presence conditioned actions are triggered, then the process passes to block 1426. Block 1426 depicts performing the triggered actions, and the process ends.

Returning to block 1402, if there is a change in buddy presence detected, the process passes to block 1406. Block 1406 depicts the messaging agent updating the dynamic buddy list with the change in buddy presence. Next, block 1408 illustrates a determination by the messaging agent of which type of buddy presence change occurred. In the example, “available” is an indicator that the buddy is logged on and receiving messages and “unavailable” is an indicator that the buddy is not receiving messages. It will be understood that the buddy presence indicators of “available” or “not available” may be inferred from other presence indicators and that buddy presence indicators may be more descriptive.

At block 1408, if the buddy presence indicator changed to “not available”, then the process passes to block 1410. Block 1410 depicts the messaging agent adding a “set presence conditioned actions” option for the buddy in the dynamic buddy list display window, and the process ends.

In addition, at block 1408, if the buddy presence indicator changed to “available”, then the process passes to block 1412. Block 1412 depicts the messaging agent searching the dynamic buddy list for presence conditioned actions triggered by the change in presence and any other criteria being met. Next, block 1414 depicts a determination by the messaging agent whether any presence conditioned actions are triggered. For a presence conditioned action to be triggered, both the presence based and non-presence based conditions for the action must be met. If the messaging agent does not detect any triggered presence conditioned actions, then the process ends. If the messaging agent does detect triggered presence conditioned actions, then the process passes to block 1416. Block 1416 depicts performing the triggered actions, and the process ends.

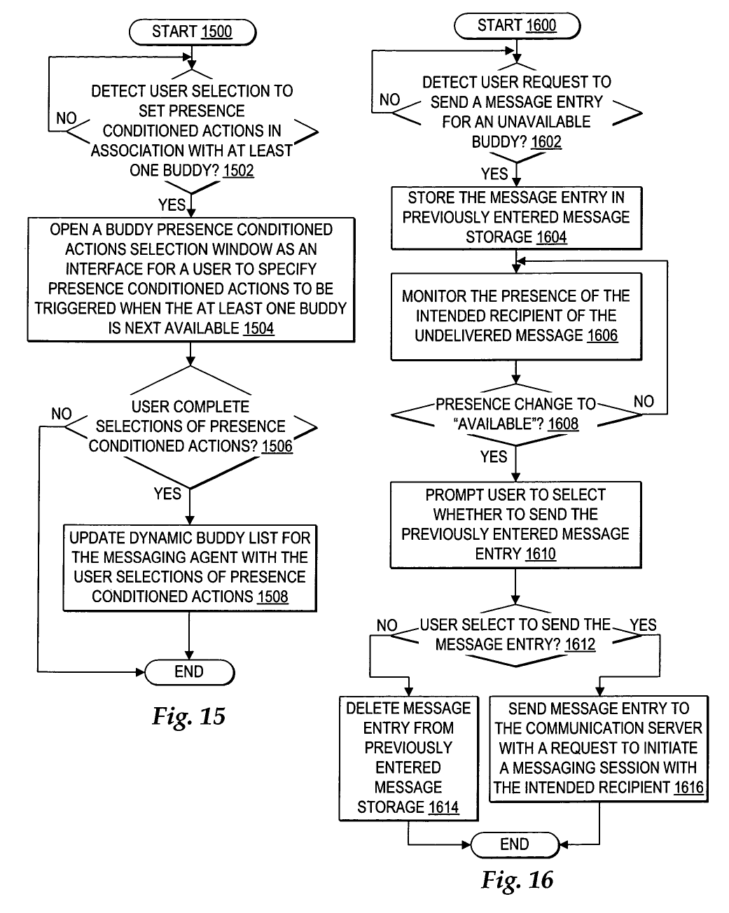

With reference now to FIG. 15, a high level logic flowchart depicts a process and program performed by a messaging agent in facilitating a user selection of presence conditioned actions. As illustrated, the process performed by the messaging agent starts at block 1500 and thereafter proceeds to block 1502. Block 1502 depicts a determination whether the messaging agent detects a user selection to set presence conditioned actions in association with at least one buddy who is unavailable. If the messaging agent detects a user selection to set presence conditioned actions, then the process passes to block 1504. Block 1504 illustrates opening a buddy presence conditioned actions selection window as an interface for a user to specify presence conditioned actions to be triggered when at least one selected buddy is next available. Next, block 1506 depicts a determination by the messaging agent whether the user has completed a selection of presence conditioned actions. If the user does not make a selection of presence conditioned actions, then the process ends. If a user completes a selection of presence conditioned actions, then the process passes to block 1508. Block 1508 depicts updating the dynamic buddy list for the messaging agent or updating the dynamic buddy list database for the communication server with the user selections of presence conditioned actions, and the process ends.

Referring now to FIG. 16, a high level logic flowchart depicts a process and program performed by a messaging agent in facilitating a user selection of conditions for a message entry intended for a recipient who is currently unavailable. As illustrated, the process starts at block 1600 and thereafter proceeds to block 1602. Block 1602 depicts a determination whether the messaging agent detects a user requests to send a message to a buddy who is unavailable. If the messaging agent detects a message request for an unavailable buddy, then the process passes to block 1604. Block 1604 depicts storing the message entry in previously entered message storage. Next, block 1606 illustrates the messaging agent monitoring the availability of the intended recipient of the undelivered message request. Thereafter, block 1608 depicts a determination by the messaging agent whether the intended recipient presence changes to “available”. If the intended recipient presence does not change to “available”, then the process returns to block 1606. Otherwise, if the intended recipient presence changes to “available”, then the process passes to block 1610. Block 1610 depicts prompting the user to select whether to send the previously undelivered message to the intended recipient. Next, block 1612 illustrates a determination whether the user selects to send the previously undelivered message. If the user does not select to send the previously undelivered message, then the messaging agent deletes the message from the storage system, as depicted at block 1616, and the process ends. If the user does select to send the previously undelivered message, then the messaging agent sends the message entry to the communication server with a request to initiate a messaging session with the intended recipient, as depicted at block 1616, and the process ends.

With reference now to FIG. 17, an illustrative example depicts a presence conditioned action selection window when there are multiple intended recipients of a message entry. In particular, a messaging session may include multiple participants or intended participants. For example, a sender may schedule multiple users to participate in a single messaging session.

According to an advantage, a user may specify presence conditioned actions for a multiple recipient messaging session, as illustrated in presence conditioned actions selection window 1700. In particular, as indicated at reference numeral 1702, a user may specify an intended session name and time frame for the intended messaging session. In addition, the user may specify the intended participants and a level of security level required for participants.

In one embodiment, the user may select for action controller 330 to automatically initiate the messaging session at the time indicated in each user's schedule. In another embodiment, however, the user may specify presence conditioned actions for initiating the messaging session. In one example, a user may specify to automatically initiate the chat session with the message entry indicated at reference numeral 1704 when a selection of users are available, as illustrated at reference numeral 1710.

In another example, as indicated at reference numeral 1706, a user may select to receive an alert when a particular user “SALLYJONES” enters the chat session and as indicated at reference numeral 1714, a user may select to receive an alert when any user with only “level 2 security” enters the chat session. In another example, as indicated at reference numeral 1708, a user may select to receive an alert when “BILLJONES” enters the chat session and to receive the option to send the message entry. Further, as illustrated at reference numeral 1712, a user may select to automatically e-mail the message entry to the intended chat session participants if not all join by 5 PM.

While the invention has been particularly shown and described with reference to a preferred embodiment, it will be understood by those skilled in the art that various changes in form and detail may be made therein without departing from the spirit and scope of the invention.

1. A method for handling an undelivered message entry intended for communication in a messaging session, wherein at least one messaging system communicatively connected in a network enables communication by at least one messaging session, comprising:
storing, by a first computer, a message entry by a user received at said first computer from said at least one messaging system, wherein said message entry is intended for communication in a messaging session with an intended recipient who is unavailable to receive said message entry when said message entry is entered by said user, wherein said first computer controls distribution of said message entry to said intended recipient at at least one separate client system communicatively connected to said network according to at least one presence conditioned action that designates a condition for action for distributing said message entry, wherein said condition is based on a presence of said intended recipient as available or unavailable and at least one non-presence based requirement;
monitoring by said first computer whether said condition is satisfied; and
responsive to detecting that said condition is satisfied, performing by said first computer said action for distributing said message entry to said at least one separate client system.

2. The method according to claim 1, wherein said storing step further comprises:
receiving by said first computer said message entry entered by said user during an ongoing messaging session, wherein said intended recipient is participating in said ongoing messaging session;
attempting to deliver said message entry from said first computer during said ongoing messaging session to said intended recipient;
receiving at said first computer an update that said message entry is undeliverable because said presence of said intended recipient has changed from available to unavailable; and
responsive to receiving said update that said message entry is undeliverable, storing by said first computer said message entry.

3. The method according to claim 1, wherein said storing step further comprises:
providing by said first computer a user interface through which said user enters said message entry intended for said intended recipient while said intended recipient is unavailable to receive message entry; and
responsive to detecting said message entry entered by said user, storing by said first computer said message entry.

4. The method according to claim 1, wherein said detecting step further comprises:
querying by said first computer a second computer for said presence of said intended recipient, wherein said second computer monitors said presence of said intended recipient to receive communications.

5. The method according to claim 1, wherein said prompting step further comprises:
automatically enabling by said first computer display of a messaging window with said message entry and a selectable option, wherein upon selection of said selectable option, a messaging agent initiates said messaging session with said intended recipient starting with said message entry.

6. The method according to claim 1, wherein said non-presence based requirements further comprises at least one of a current time zone of operation of said intended recipient, a current geographical location of said intended recipient, and a domain name identifying said user compared with a domain name identifying said intended recipient.

7. The method according to claim 6, wherein said action comprises at least one from among an automatic initiation by said first computer of said messaging session with said message entry, an automatic creation and submission by said first computer of an electronic mail comprising said message entry, and an automatic distribution by said first computer of said message entry to an alternate message device.

8. The method according to claim 1, wherein said condition further comprises a time after which distribution of said message entry to said at least one client system is automatically triggered.

9. A system for handling an undelivered message entry intended for communication in a messaging session, comprising:
a data storage medium communicatively accessible within a network for storing a message entry by a user, wherein said message entry is intended for communication in a messaging session as enabled by at least one messaging service provider via said network with an intended recipient who is unavailable to receive said message entry when said message entry is entered by said user; and
a first computer means for controlling distribution of said message entry from said data storage medium to said intended recipient at at least one separate client system communicatively connected to said network according to at least one presence conditioned action that designates a condition for action for distributing said message entry, wherein said condition is based on a presence of said intended recipient as available or unavailable and at least one non-presence based requirement;
said first computer means for monitoring whether said condition is satisfied; and said first computer means, responsive to detecting that said condition is satisfied, for performing said action for distributing said message entry from said data storage medium to said at least one separate client system.

10. The system according to claim 9, said first computer means further comprising:
means for receiving said message entry entered by said user during an ongoing messaging session, wherein said intended recipient is participating in said ongoing messaging session;
means for attempting to deliver said message entry during said ongoing messaging session to said intended recipient;
means for receiving an update that said message entry is undeliverable because said presence of said intended recipient has changed from available to unavailable; and
means, responsive to receiving said update that said message entry is undeliverable, for directing storage of said message entry in said data storage medium.

11. The system according to claim 9, said first computer means further comprising:
means for providing a user interface through which said user enters said message entry intended for said intended recipient while said intended recipient is unavailable to receive message entry; and
means, responsive to detecting said message entry entered by said user, for directing storage of said message entry in said data storage medium.

12. The system according to claim 9, said first computer means further comprising:
means for querying a second computer for said presence of said intended recipient, wherein said second computer monitors said presence of said intended recipient to receive communications.

13. The system according to claim 9, said first computer means further comprising:
means for automatically enabling display of a messaging window with said message entry and a selectable option, wherein upon selection of said selectable option, a messaging agent initiates said messaging session with said intended recipient starting with said message entry.

14. The system according to claim 9, said first computer means further comprising said non-presence based requirement comprising at least one of a current time zone of operation of said intended recipient, a current geographical location of said intended recipient, and a domain name identifying said user compared with a domain name identifying said intended recipient.

15. The system according to claim 14, wherein said action comprises at least one from among an automatic initiation by said first computer means of said messaging session with said message entry, an automatic creation and submission by said first computer means of an electronic mail comprising said message entry, and an automatic distribution by said first computer means of said message entry to an alternate message device.

16. The system according to claim 16, said first computer means further comprising said condition comprising a time after which distribution of said message entry to said at least one client system is automatically triggered.

17. A program for handling an undelivered message entry intended for communication in a messaging session, said program embodied in a computer-readable medium, said program comprising computer-executable instructions which cause a computer to perform the steps of:
controlling storage of a message entry by a user received from at least one messaging system enabling messaging session communications, wherein said message entry is intended for communication in a messaging session with an intended recipient who is unavailable to receive said message entry when said message entry is entered by said user;
monitoring by said first computer whether a condition is satisfied, wherein at least one presence condition action designates said condition for action for distributing said message entry to said intended recipient, wherein said condition is based on a presence of said intended recipient as available or unavailable and at least one non-presence based requirement; and
responsive to detecting that said condition is satisfied, performing said action for distributing said message entry to said intended recipient.

18. The program according to claim 17, wherein said step of storing a message entry by a user further comprises the steps of:
receiving said message entry entered by said user during an ongoing messaging session, wherein said intended recipient is participating in said ongoing messaging session;
attempting to deliver said message entry during said ongoing messaging session to said intended recipient;
receiving an update that said message entry is undeliverable because said presence of said intended recipient has changed from available to unavailable; and
responsive to receiving said update that said message entry is undeliverable, storing said message entry.

19. The program according to claim 17, wherein said step of storing message entry by a user further comprises the steps of:
providing a user interface through which said user enters said message entry intended for said intended recipient while said intended recipient is unavailable to receive message entry; and
responsive to detecting said message entry entered by said user, storing said message entry.

20. The program according to claim 17, wherein said step of detecting a change in presence of said intended recipient from unavailable to available, further comprises the step of:
querying a second computer for said presence of said intended recipient, wherein said second computer monitors said presence of said intended recipient to receive communications.
